(19) United States
(12) Patent Application Publication
(10) Pub. No.: US 2001/0040548 A1
(43) Pub. Date: Nov. 15, 2001

(54) LCD and method for driving same

(75) Inventor: Naoyasu Ikeda, Tokyo (JP)

Correspondence Address: HELFGOTT & KARAS P.C., 60th Floor, Empire State Building, New York, NY, 10118-0110, US

(73) Assignee: NEC CORP

(21) Appl. No.: 09/750,883

(22) Filed: Dec. 28, 2000

(30) Foreign Application Priority Data
Dec. 28, 1999 (JP) 11-372759

(51) Int. Cl. G09G 3/36

(52) U.S. Cl. 345/92; 345/99; 345/100

(57) ABSTRACT

A ramp voltage-generating circuit initially outputs the maximum voltage VH or the minimum voltage VL to be applied to a liquid crystal synchronizing with a ratch pulse and a clock II. In case that the maximum voltage VH is outputted initially, the output voltage of the ramp voltage-generating circuit decreases slowly with the passage of time in a predetermined period. In case that the minimum voltage is outputted initially, the output voltage of the ramp voltage-generating circuit increases slowly with the passage of time in a predetermined period. The output voltage of the ramp voltage-generating circuit keeps VH in the period T3, slowly decreases in the period T4, and keeps V0 in the period T5. In a LCD provided with the ramp voltage-generating circuit mentioned in the above, a voltage impressed upon the pixel electrode of a TFT for driving the liquid crystal follows an input voltage of a data bus line quickly, and a contrast of a picture can be prevented from being deteriorated.

### FIELD OF THE INVENTION

The invention relates to a Liquid Crystal Display (LCD, hereinafter) and a method for driving the same, and especially to a LCD of an active matrix type which controls brightness of each pixel on the basis of a gray scale level of an input video signal and a method for driving the same.

### BACKGROUND OF THE INVENTION

The LCD has come to be used in various fields because of features thereof, such as compactness, light weight, and low consumed power. Especially, since the LCD of an active matrix type, in which each pixel is controlled by a switching element such as a thin film transistor (TFT, hereinafter), can control brightness of each pixel in accordance with an input video signal level and display a picture in condition that a cross talk between adjacent electrodes is negligible even when scanning lines are densely distributed, this LCD is successfully used in a television receiver and a display of a personal computer.

FIG. 1 is a block diagram for showing a structure of the LCD of the active matrix type using the TFT as the switching element. In the structure shown FIG. 1 is composed of a LCD cell 1, data bus lines 4, gate bus lines 5, the TFTs 6, a data-driver circuit 14, and a gate driver circuit 15. The liquid crystal cell 1 is composed of a pixel electrode 2 for driving a liquid crystal, a counter electrode 3 situated opposite to the pixel electrode 2, and a liquid crystal inserted between the pixel electrode 2 and the counter electrode 3. The data bus line 4 supplies a voltage to be impressed upon the pixel electrode 2. The gate bus line 5 supplies a signal for determining a row to which the pixel electrodes 2 to be supplied with the voltages of the data bus lines 4 belong. The TFT 6 supplies the voltage of the data bus line 4 to the pixel electrode 2 in accordance with the signal supplied from the gate bus line 5. The data driver circuit 14 generates a voltage to be supplied to the data bus lines 4. The gate-driver circuit 5 successively selects the gate bus line 5 to output a signal for making the TFT 6 turn on.

In the LCD of the active matrix type shown in FIG. 1, it is necessary to change the voltage applied to each of the pixel electrodes 2 in accordance with a level of the input video data in order to display a picture excellently. In general, a circuit for controlling brightness of each pixel on the basis of the gray scale level of the input video data is built in a data driver circuit 14.

A circuit of this kind is disclosed in Japanese patent applications laid-open, No. 63-161495 for instance. FIG. 2 shows an outline of a structure of the circuit for controlling brightness of each pixel on the bais of the gray scale level of the input video data. As shown in FIG. 2, in this conventional technology, the data-driver circuit is provided with plural different reference voltage 16 to 19, one of which is selected by switches 20 to 23 in accordance with an input video data and supplied to a data bus line. Since the data driver circuit shown in FIG. 2 is provided with the four kinds of the reference voltages, brightness of the pixel is controlled in four steps, in other words the gray scale level of the brightness is four. However, since the number of the reference voltages is the same as that of the steps of brightness according to the aforementioned method, if this method is applied to televisional pictures or computer graphic arts which have high quality and are displayed in the three primary colors, the number of the reference voltages increases sharply, the apparatus is magnified, and consumed electric power increases.

Another method for solving the aforementioned problem is disclosed in Japanese patent applications laid-open, No. 64-10298. FIG. 3 shows a block diagram for showing a data-driver circuit used in this technology, and FIG. 4 shows timing charts of voltages of various important portions of the data driver circuit. As shown in FIG. 3, a LCD-driving circuit used in this conventional technology is composed of a ramp voltage-generating circuit 24 for generating a reference voltage with a triangular wave form, ratches 31₁, 31₂, . . . , 31ₙ for ratching signals of transfer stages 30₁, 30₂, . . . , 30ₙ of a shiftregister which transfers input data supplied from an input terminal 25, decoders for pulse width modulation 32₁, 32₂, . . . , 32ₙ which respectively convert data stored in the ratches into square pulses having widths corresponding to the data, sampling & holding circuits respectively composed of sampling & holding condencers 33₁, 33₂, . . . , 33ₙ and sampling & holding switches 34₁, 34₂, . . . , 34ₙ, and output buffer amplifiers 35₁, 35₂, . . . , 35ₙ.

A video data Vd is inputted to the shiftregister via the input terminal 25, transferred through the transfer stages 30₁, 30₂, . . . , 30ₙ of the shift register and ratched by the ratches 31₁, 31₂, . . . , 31ₙ which start to operate in accordance with a ratch pulse Ve supplied via a ratch pulse input terminal 26. The data ratched by the ratches 31₁, 32₂, . . . , 31ₙ are held during a period of the next horizontal scanning and are modulated by the decoders for pulse width modulation 32₁, 32₂, . . . , 32ₙ which are supplied with a reference clock pulse via a reference clock pulse input terminal 27, wherein the maximum width of the pulse width modulated signal is less than the period of the horizontal scanning.

On the other hand, the ramp voltage Va is generated by the ramp voltage-generating circuit 24 responding to a ramp voltage start pulse Vb which synchronizes with the horizontal scanning and inputted via a ramp start pulse input terminal 28, and supplied to input terminals of the sampling & holding switches 34₁, 34₂, . . . , 34ₙ. In general, the ramp voltage Va having an alternating triangular wave form shown in FIG. 4 is used in the data-driver circuit in order to prevent the liquid crystal form being deteriorates. In FIG. 4, T1 is a period in which the ramp voltage Va is positive, and T2 is a period in which the ramp voltage Va is negative.

The sampling & holding switches 34₁, 34₂, . . . , 34ₙ are closed only while the pulse width modulated signals Vc which are generated by the decoders for pulse width modulation 32₁, 32₂, . . . , 32ₙ are at the high logical level, and charge the sampling & holding condensers 33₁, 33₂, . . . , 33ₙ with the voltages which are perspectively proportional to the widths of the pulses. As shown in FIG. 4, the voltage of the sampling & holding condenser Vf decreases or increases in the sampling period of the sampling & holding circuit (while Vc is at the high logical level), and holds the final data in the sampling period after the holding period starts (while Vc is at the low logical level). Then, the voltages of the sampling & holding condenser Vf are respectively amplified by the output buffer amplifiers 35₁, 35₂, . . . , 35ₙ and outputted to the data bus lines 4 via output terminals 36₁, 36₂, . . . , 36ₙ.

According to the aforementioned method, all the voltages extending from the minimum value to the maximum value can be supplied to the data bus lines in the period T1 or T2 in which a certain horizontal scanning line is selected, and the LCD can cope with a full color display. Since an output voltage of a single ramp voltage-generating circuit is enough as the reference voltage to be applied to the liquid crystals, the LCD can be small-sized and consumed electric power can be reduced.

However, in the LCD-driving circuit using the ramp voltage-generating circuit disclosed in Japanese patent applications laid-open , No. 64-10298, a low voltage is applied to the data bus line immediately after a scanning line is going to be selected and the voltage applied thereto increases slowly thereafter in the period T1 shown in FIG. 4 At this time, the voltage of the pixel electrode does not follow the voltage supplied to the data bus line immediately, but lags behind that as shown in FIG. 5 in accordance with the current-supplying capability of the TFT and a capacity of the pixel electrode, and narrowly follows the voltage of the data bus line within the period T1. Moreover, since the sign of the voltage applied to the pixel electrode alternates between positive and negative in every frame, the time lag becomes noticeable especially in case that the voltage applied to the pixel electrode changes from the negative minimum value to the positive maximum value. Accordingly, in case that the capability of the TFT in supplying the current to the pixel electrode is insufficient because of the low carrier mobility of the active layers or narrowness of the channel width of the TFT, the voltage of the pixel electrode may not reach that of the data bus line within a period that the scanning line is selected. This situation similarly occurs in case that the voltage applied to the pixel electrode is negative in the period T2 shown in FIG. 5, and the voltage of the pixel electrode may not decrease to the voltage of the data bus line. As a result, a voltage corresponding to the desired brightness signal cannot be applied to the pixel electrode, hence the transmissivity of the liquid crystal is not reduced sufficiently in case that the pixel is displayed in a black color and thereby contrast of the picture deteriorates. Although this problem can be solved by improving the current-supplying capability of the TFT, since it is not simple to increase the carrier mobility of the active layers, the elevation of the driving capability of the TFT can be achieved only by increasing a width of the channel in general, hence the elevation of the driving capability of the TFT brings about deterioration of an aperture ratio of the pixel.

### SUMMARY OF THE INVENTION

Accordingly, it is an object of the invention to provide a LCD and a method for driving the same, in which a voltage applied to the pixel electrode quickly follows that applied to a data bus line without deteriorating an aperture ratio of a pixel and prevents a contrast of a picture from being deteriorated.

According to the first feature of the invention, a LCD comprises:

a LCD panel which is composed of gate bus lines, data bus lines intersecting the gate bus lines, switching elements respectively situated close by intersections of the gate and data bus lines and connected therewith, pixel electrodes respectively connected with the switching elements, common electrodes respectively situated opposite to the pixel electrodes, and liquid crystals respectively driven by the pixel and common electrodes,

a ramp voltage-generating circuit for generating a reference voltage which is defined as a difference in a potential between an output terminal of the ramp voltage-generating circuit and the common electrodes,

wherein an absolute value of the reference voltage varies periodically synchronizing with a signal for changing the gate bus line to be selected and decreases slowly in a predetermined period, and a sign of the reference voltage alternates between positive and negative whenever the gate bus line to be selected is changed,

a data-driver circuit which is supplied with the reference voltage and video signals corresponding to respective pixels and generates brightness signals to be supplied to the respective data bus lines, and

a gate-driver circuit which is connected with the respective gatebus lines and on/off controls the respective switching elements,

wherein the absolute value of the reference voltage takes a maximum value after the sign thereof alternates, decreases slowly thereafter, and takes a minimum values in a final stage.

Moreover, it is desirable that the absolute value of the reference voltage maintains the minimum value for a certain time after it takes the minimum value, and maintains the maximum value for a certain time after it takes the maximum value.

According to the second feature of the invention, a method for driving a LCD comprising a LCD panel composed of comprises the steps of:

A method for driving a LCD comprising a LCD panel composed of gate bus lines, data bus lines intersecting the gate bus lines, switching elements respectively situated close by intersections of the gate and data bus lines and connected therewith, pixel electrodes respectively connected with switching elements, common electrodes respectively situated opposite to the pixel electrodes, and liquid crystals respectively driven by the pixel and common electrodes, comprising the steps of:

selecting the gate bus line preceding a signal for instructing a horizontal scanning to start,

supplying a reference voltage generated by a ramp voltage-generating circuit to a data driver circuit connected with the respective data bus lines,

wherein the reference voltage is defined as a difference in a potential between an output terminal of the ramp voltage-generating circuit and the common electrodes, and an absolute value of the reference voltage decreases slowly in a predetermined period,

converting video signals corresponding to respective pixels into pulse width modulated signals by means of the data-driver circuit,

supplying brightness signals to the respective data bus lines in accordance with the pulse width modulated signals and the reference voltage by means of the data-driver circuits, and

on/off controlling the respective switching elements in order to supply the respective brightness signals to the pixel electrodes by means of a gate-driver circuit connected with the respective gate bus lines.

In the LCD according to the invention, the output voltage of the ramp voltage-generating circuit takes the maximum or minimum value immediately after a certain scanning line is going to be selected, decreases slowly with the passage of time in case that the maximum value is generated, and increases slowly in case that the minimum value is generated. If a certain voltage applied to a pixel electrode belonging to a selected scanning line is watched, since an output voltage of a sampling & holding circuit can be applied to the pixel electrode for a long time as the difference in the potential applied to the pixel electrode between the present and preceding scannings is large, even a TFT with the low carrier mobility can make the voltage applied to the pixel electrode follow that applied to the data bus line easily. Moreover, since a width of a channel of the TFT can be narrowed in case that the sufficient carrier mobility is secured, the LCD can be small-sized and aperture ratio of the pixel can be increased.

### BRIEF DESCRIPTION OF THE DRAWINGS

The invention will be explained in more detail in conjunction with appended drawings, wherein:

FIG. 1 shows a block diagram for showing a structure of a LCD of an active matrix type,

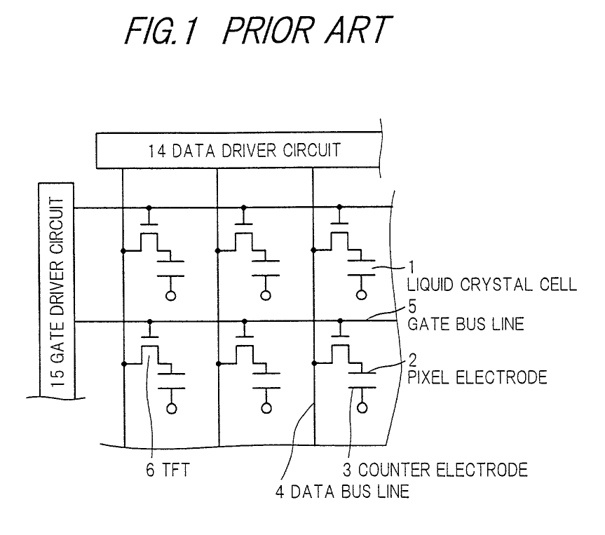

FIG. 2 shows a circuit diagram for showing a structure of the first conventional LCD,

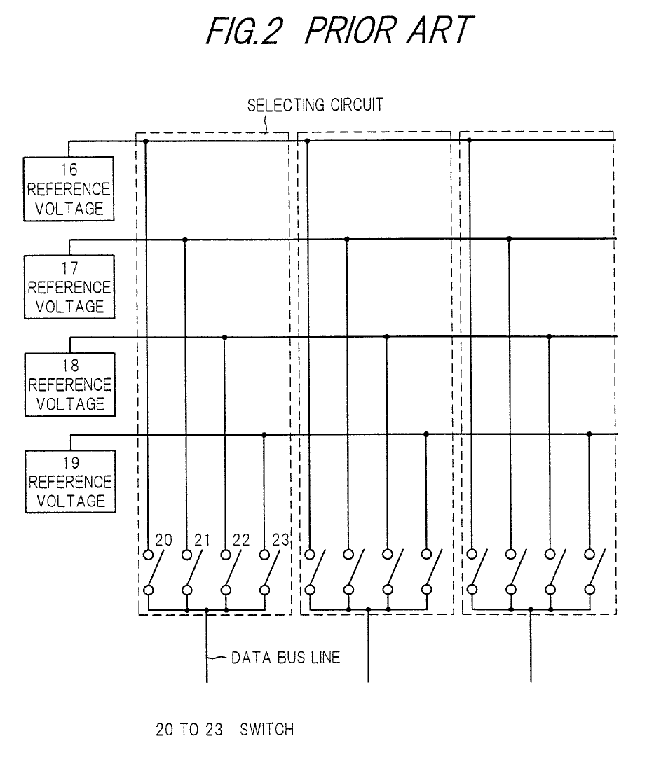

FIG. 3 shows a circuit diagram for showing a structure of the second conventional LCD,

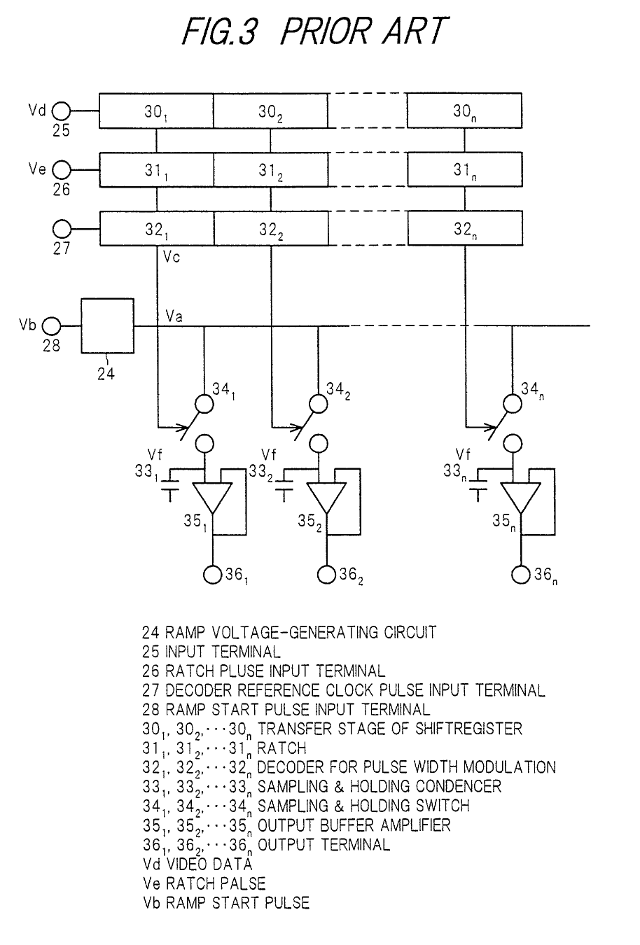

FIG. 4 shows wave forms of signal voltages applied to the second conventional LCD,

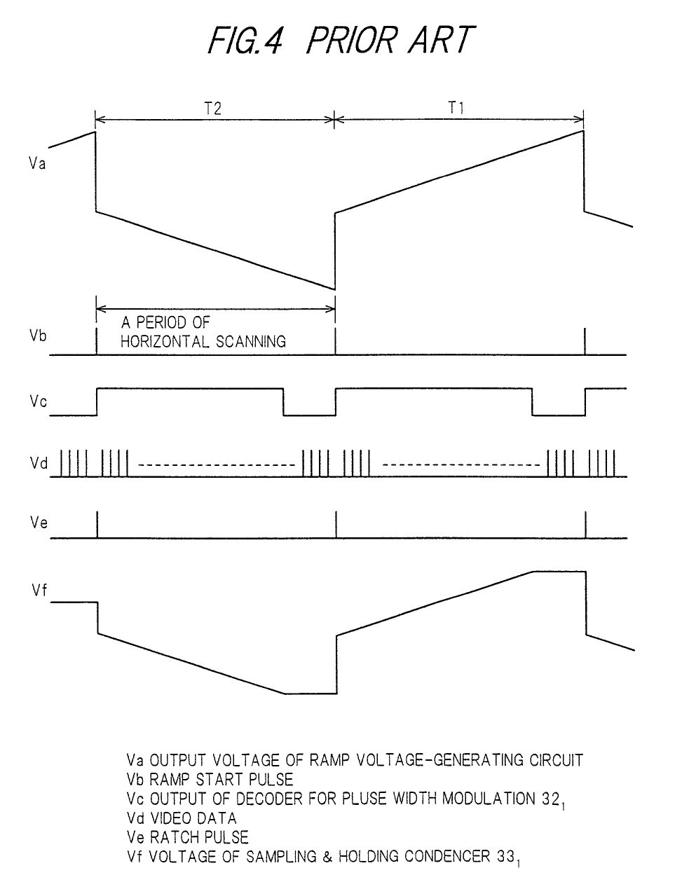

FIG. 5 shows a voltage of a pixel electrode of a TFT for driving a liquid crystal in the second conventional LCD,

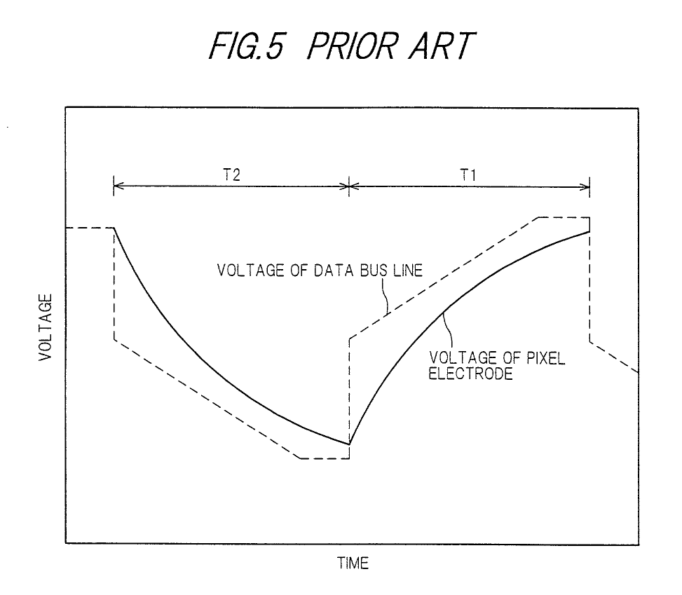

FIG. 6 shows a block diagram for showing a structure of a LCD according to the invention,

FIG. 7 shows a timing chart I for explaining an operation of a LCD according to the invention,

FIG. 8 shows a timing chart II for explaining an operation of a LCD according to the invention,

FIG. 9 shows a modified output voltage of a ramp voltage-generating circuit used in a LCD according to the invention,

FIG. 10 shows a block diagram for explaining a structure of the first preferred embodiment of the invention,

FIG. 11 shows a timing chart I for explaining an operation of the first preferred embodiment of the invention,

FIG. 12 shows a timing chart II for explaining an operation of the first preferred embodiment of the invention, and

FIG. 13 sows an output voltage of a ramp voltage-generating circuit used in the second preferred embodiment of the invention.

### DESCRIPTION OF THE PREFERRED EMBODIMENT

Next, embodiments of the invention will be explained in detail referring to the appended drawings.

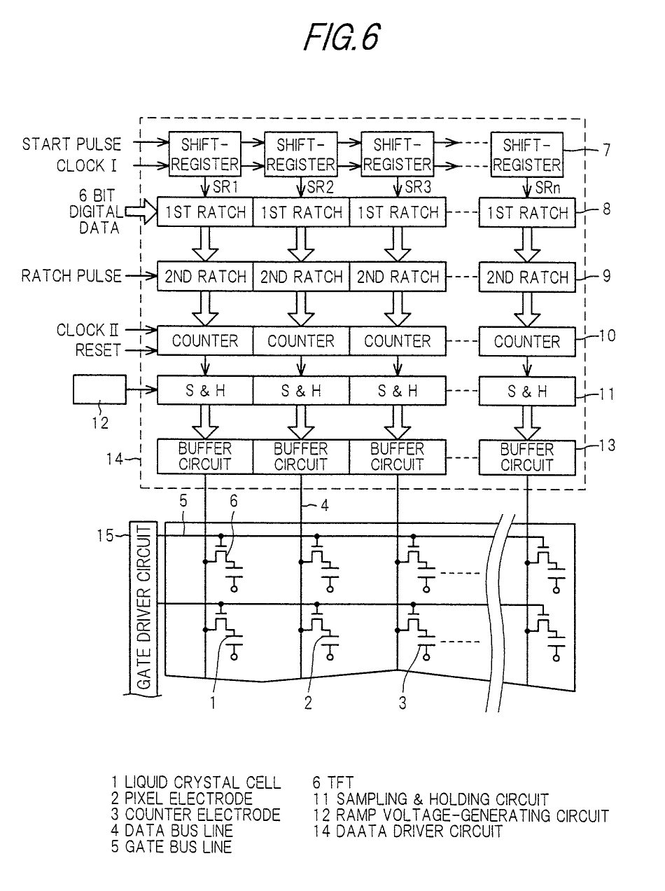

FIG. 6 is a block diagram of a LCD for explaining a preferred embodiment of the invention. The LCD comprises liquid crystal cells 1, data bus lines 4, gate bus lines 5, and the TFTs 6. The liquid crystal cell 1 is composed of a pixel electrode 2 for driving a liquid crystal, a counter electrode 3 situated opposite to the pixel electrode 2, and the liquid crystal inserted between the pixel electrode 2 and the counter electrode 3. The data bus line 4 supplies a voltage to be impressed upon the pixel electrode 2. The gate bus line 5 supplies a signal for determining a row to which the pixel electrodes 2 to be supplied with the voltages of the data bus lines 4 belong. The TFT 6 supplies the voltage of the data bus line 4 to the pixel electrode 2 in accordance with the signal supplied from the gate bus line 5.

A data-driver circuit 14 in the preferred embodiment of the invention is enclosed in a broken line as shown in FIG. 6. The data-driver circuit 14 is composed of shift registers 7, the first ratches 8, the second ratches 9, counters 10, sampling & holding circuits (represented as S & H in the drawings, hereinafter) 11, a ramp voltage-generating circuit 12, and buffer circuits 13. The shift registers 7 are supplied with a start pulse, and shifts it in accordance with a clock I to output ratch pulses SR1, SR2, SR3, . . . , SRn successively. Each of the first ratches 8 takes into a digital data serving as a video signal in accordance with an output signal SRi (i=1, 2, 3, . . . , n) of the shiftregisters 7. Each of the second ratches 9 takes into an output of the first ratch 8 responding to a ratch pulse. Each of the counters 10 is reset by a rest signal, counts a clock II subsequently, outputs a signal at the low logical level till a counted data therein becomes the same as an output data of the second ratch 9, and outputs a signal at the high logical level while the counted data exceeds the output data of the second ratch 9. Each of the sampling & holding circuits 11 samples an output voltage of the ramp voltage-generating circuit 12 while the signal outputted from the counter 10 is at the low logical level, and holds the same while the signal outputted from the counter 10 is at the high logical level. Each of the buffer circuits 13 converts an output impedance of the sampling & holding circuit 11, and supplies an output voltage thereof to the data bus line 4.

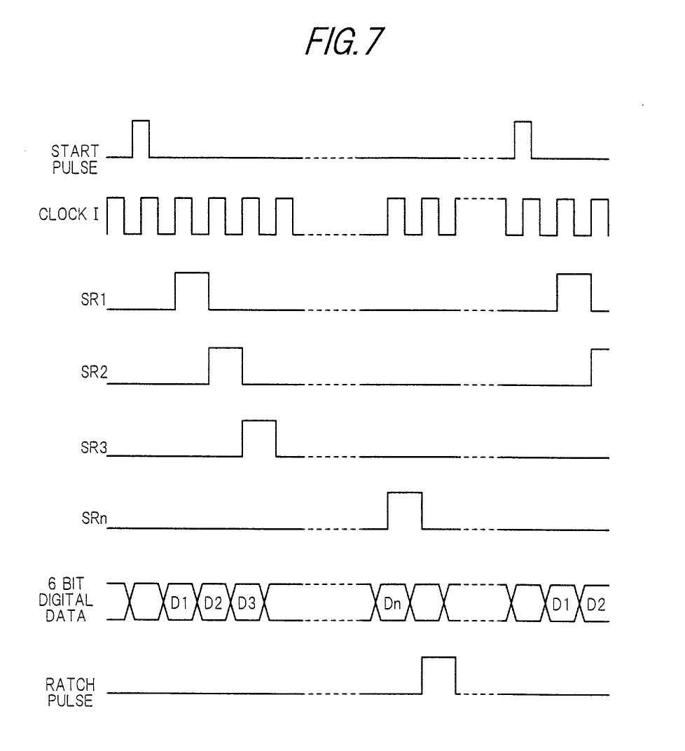

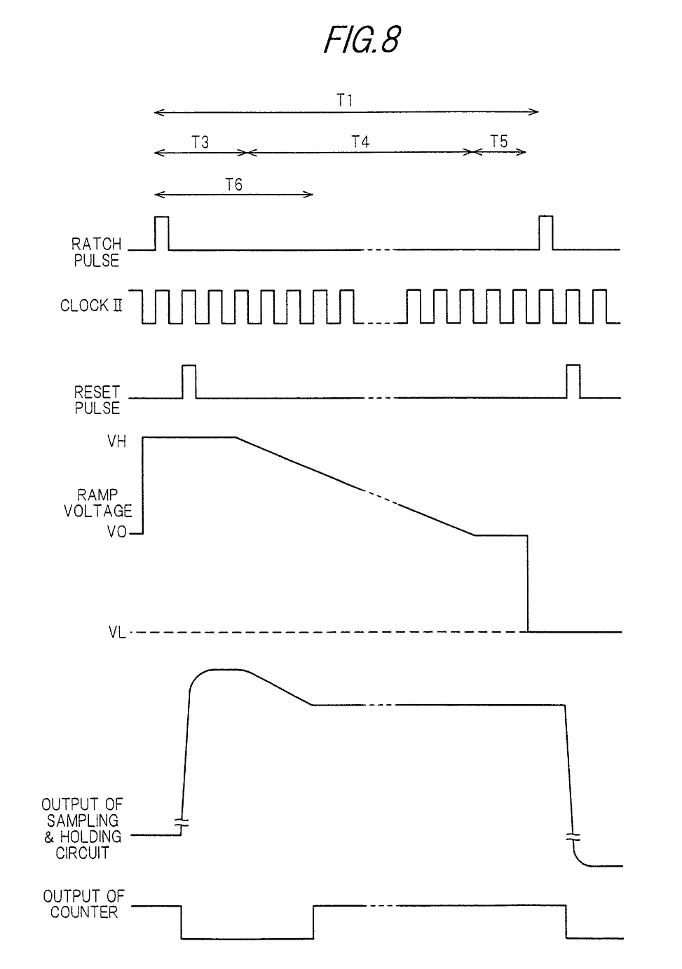

Next, an operation of the LCD shown in FIG. 6 will be explained referring to the appended drawings. FIGS. 7 and 8 show wave forms and timings of the respective signals shown in FIG. 6. FIG. 7 shows timing charts for explaining the operations of the shiftregisters 7, the first ratches 8 and the second ratches 9. If the start pulse is inputted, the shiftregister 7 starts to operate at the time of rise of the next clock pulse, and SR1, SR2, SR3, . . . , SRn successively become the high logical level whenever the clock I rises. Each digital data composed of 6 bits synchronizes with the clock I, and corresponds to an analog voltage supplied to a data bus line 4, which is situated at a position corresponding to an output of the shiftregister. At the time that an output of each shiftregister 7 rises to the high logical level, the digital data is stored in the corresponding first ratch 8. When the aforementioned operations are repeated n times in accordance with SR1, SR2, SR3, . . . , SRn, the high logical level is applied to an input terminal of the second ratches 9, and the data stored in the first ratches 8 are transferred to the second ratches 9 simultaneously.

Next, operations of the second ratches 9 to the buffer circuits 13 will be explained referring to FIG. 8. The counter 10 compares the data stored in the second ratch 9 responding to the ratch pulse with the number of the pulses of the clock II counted after the reset signal is inputted. The output of the counter 10 is at the low logical level in case that the number of the pulses counted after the reset pulse is inputted is less than the data stored in the second ratch 9, and at the high logical level in case that the number of the pulses counted after the reset pulse is inputted exceeds the data stored in the second ratch 9. The ramp voltage-generating circuit 12 initially outputs the maximum voltage VH or the minimum voltage VL to be applied to the liquid crystal synchronizing with the ratch pulse and the clock II. If the maximum voltage VH is outputted initially, the output voltage of the ramp voltage generating circuit 12 decreases slowly with the passage of time within a period of the horizontal scanning. If the minimum voltage VL is outputted initially, the output voltage of the ramp voltage-generating circuit 12 increases slowly with the passage of time similarly to the aforementioned case. In FIG. 8, the output voltage of the ramp voltage-generating circuit 12 is shown as a function of time, wherein it takes the maximum value VH at the beginning of a period T1. In this drawings, a difference between VH and V0 is the same as that between V0 and VL. The output voltage of the ramp voltage-generating circuit 12 maintains VH in a period T3, decreases slowly in a period T4, and maintains V0 in a period T5. The output of the counter 10 is at the high logical level after a period T6 has passed. In this embodiment, the LCD is supposed to be driven in the normally white mode, and a width of a pulse outputted from the counter 10 (a period in which the output of the counter 10 is at the low logical level) is wide as brightness is high. The output of the sampling & holding circuit 11 varies with the passage of time depending on the output of the counter 10 as shown in FIG. 8.

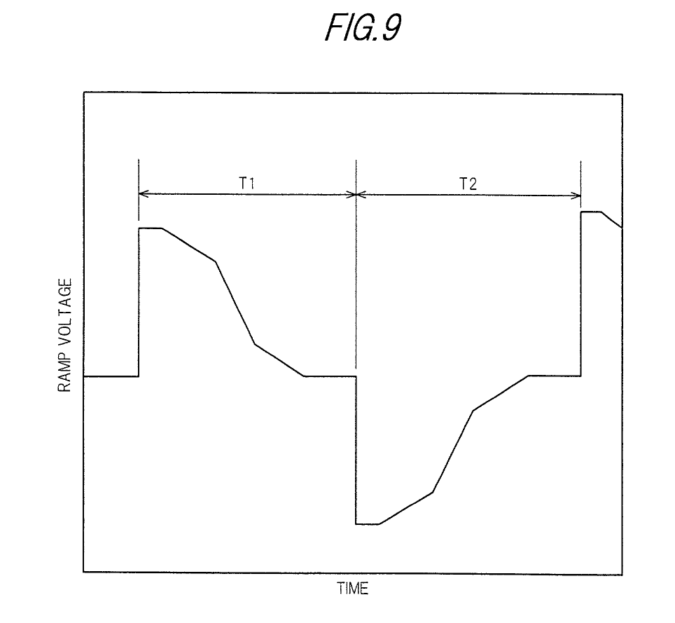

It is evident that a dependency of the output voltage of the ramp voltage-generating circuit 12 on time is never restricted to that shown in FIG. 8, and a similar effect can be obtained in case that an inclination of the output voltage of the ramp voltage-generating circuit 12 is not constant, being either increasing or decreasing, in the period of the horizontal scanning as shown in FIG. 9.

Next, the embodiments of the invention will be explained in detail referring to the appended drawings.

[The first preferred embodiment]

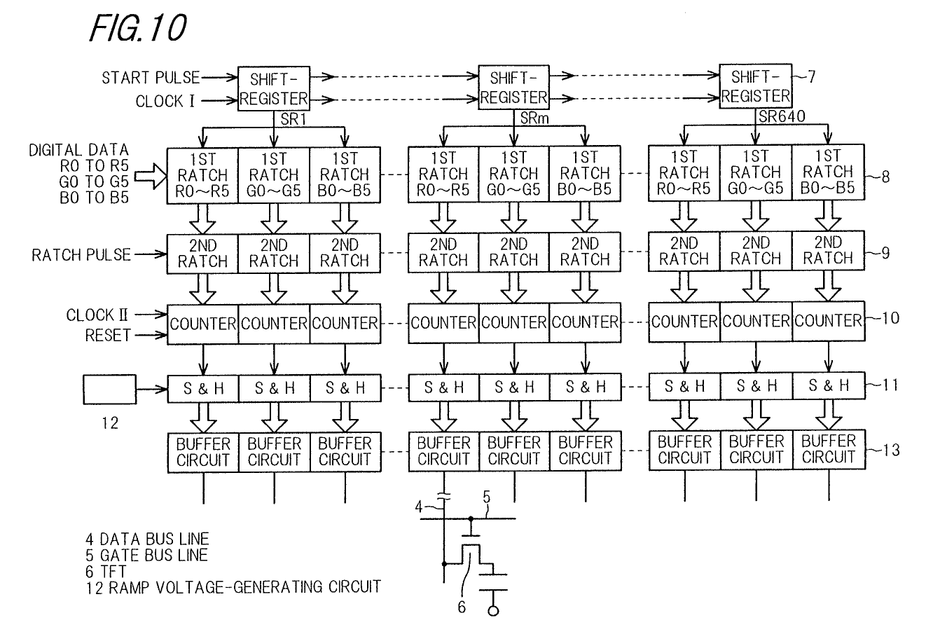

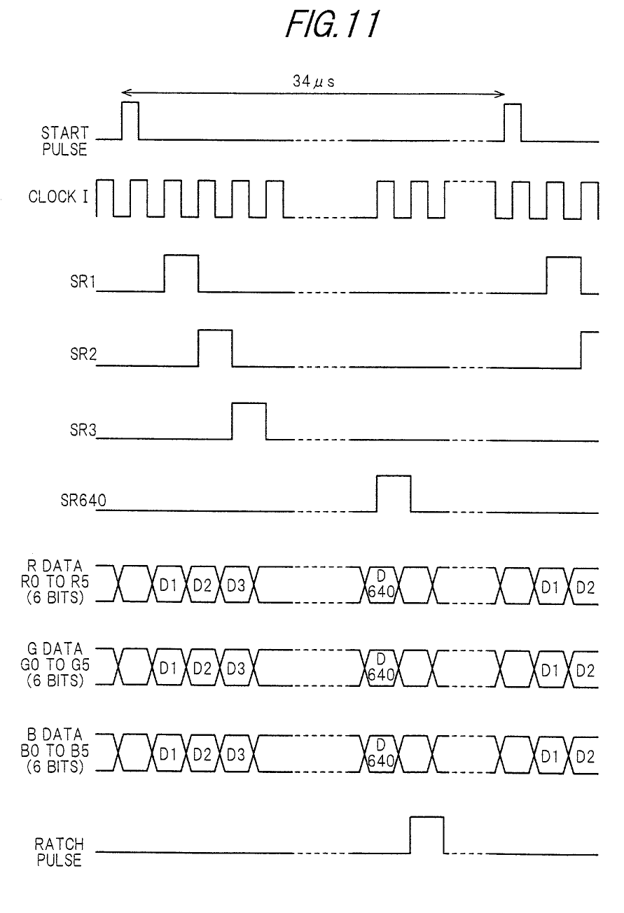

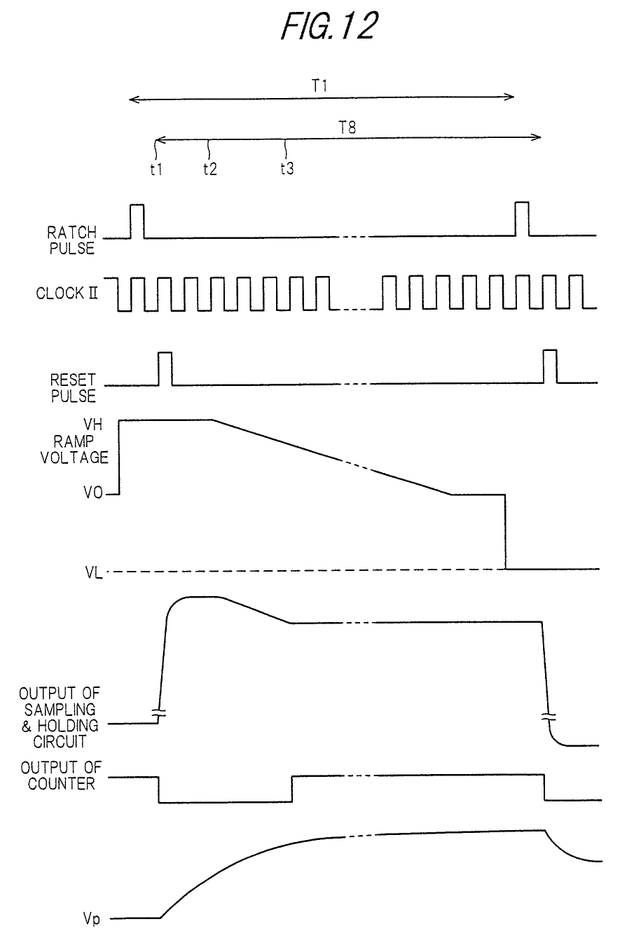

FIG. 10 is a block diagram of a data driver circuit of an LCD of an active matrix type driven in a normally white mode. A diagonal dimension of a display is 4 inch, and an arrangement of pixels therein is 640 dots horizontally×RGB×480 dots vertically. FIGS. 11 and 12 show timing charts of the respective signals. Each of the color video data RGB is composed of 6 bits. The pixel is composed of stripes arranged from the left to the right in the order of RGB.

If the first ratch 8, the second ratch 9, the counter 10, the sampling & holding circuit 11, and the buffer circuit 13, which are arranged in the vertical direction, are regarded as a circuit group in FIG. 10, this embodiment of the invention is composed of 640×RGB=1920 circuit groups. Since the RGB video signals constituting the same pixel are supplied simultaneously, these video signals are sampled at the same time, hence the number of stages of the shift registers 7 is 640.

In the aforementioned circuit structure, when the start pulse with a period of about 34 μs shown in FIG. 11 is inputted, the outputs of the shift registers 7 are successively transferred responding to the rise of the clock I which is synchronized with the start pulse. Accordingly, the video data R0 to R5, G0 to G5, B0 to B5, which respectively correspond to the RGB video signals, are ratched by the first ratches 8 simultaneously. These operations are repeated 640 times in the first to 640th shift registers, and 1920 data are ratched by the by the first ratches 8 in the period of the period of the start pulse. Still more, these ratched data are transferred to the second ratches simultaneously responding to the ratch pulse of 64.

Next, in the period of the reset pulse T8 shown in FIG. 12, an analog signal is supplied to the data bus line 4 on the basis of the digital data stored in the second ratch 9. In an example shown in FIG. 12, the gray scale level of brightness is 64, and the video data R0 to R5 corresponding to the fifth lowest brightness is ratched in a circuit group which is connected with the m th (1<m<640) shift register shown in FIG. 10 and used for a red color-display. This data is ratched by the second ratch 9 which is communicated with the mth shift register 7 and used for a red-color display. At the time t1, the counter 10 is supplied with the reset signal, and the output thereof changes into the low logical level. At this time, the ramp voltage-generating circuit 12 has outputted the maximum voltage VH, which is maintained till the time t2. Thereafter, the output voltage of the ramp voltage-generating circuit 12 decreases slowly so as to become V0 when the counter 10 has counted the clock signal II 64 times. On the other hand, the counter 10 compares the data stored in the second ratch 9 with the number of the clock pulses II counted by the counter 10, and the output of the counter 10 changes into the high logical level when five pulses are inputted thereto (a the time t3 in FIG. 12). Since then, the sampling & holding circuit 11 holds the output voltage of the ramp voltage-generating circuit 12 generated at the time t3, which is supplied to the buffer circuit 13. This output voltage of the sampling & holding circuit 11 is maintained in the period T8, and changed into the next signal in accordance with the next rest pulse. Vp shown in FIG. 12 means a voltage applied to the pixel electrode 2 which is driven by a TFT 6 connected with the gate bus line 5 selected in this period.

[The second preferred embodiment]

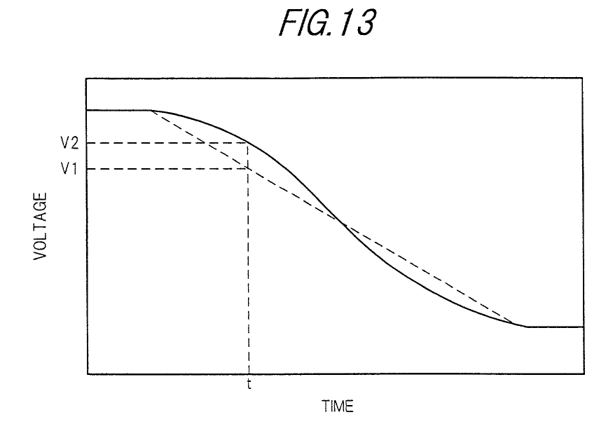

In the second preferred embodiment, an apparatus having a similar structure to that used in the first preferred embodiment is used also. FIG. 13 shows the output voltage of the ramp voltage-generating circuit used in the second preferred embodiment as a function of time. The operations of the circuits are similar to those used in the first preferred embodiment shown in FIGS. 10, 11, and 12.

In FIG. 13, a real line shows the output of the ramp voltage-generating circuit used in the second preferred embodiment, and a broken line shows that used in the first preferred embodiment. In case that two kinds of the output voltages of the ramp voltage-generating circuit shown in FIG. 13 are used, even if the same digital data is sampled at the same time t, the voltages outputted from the buffer circuits finally take different values, V1 and V2. As mentioned in the above, if the shape of the output voltage of the ramp voltage-generating circuit is made nonlinear so that a transmissivity against voltage characteristic of the liquid crystal is compensated, the input data can be displayed smoothly in accordance with the input data.

Although the explanations have been given to the preferred embodiments in the above descriptions, applications of the inventions are never restricted to the aforementioned embodiments, and various modifications and improvements thereof can be devised so long as they do not deviate from the substance of the invention. For example, although the video data is a digital data in the aforementioned embodiment, the invention can be applied to a case that the video data is an analog data so long as a predetermined output voltage of the ramp voltage-generating circuit can be held. The method for sampling & holding an analog signal on the basis of the digital data is never restricted to the one mentioned in the aforementioned embodiments, and the other well known method may be adopted. Although each digital data is composed of 6 bits in the aforementioned embodiments, it is evident that the number of the bits of the digital data supplied to the digital data driver circuit is never restricted to six. Although the output voltage of the ramp voltage-generating circuit keeps the maximum voltage VH in a certain period, decreases slowly in a certain period, and keeps the voltage V0 in a certain period in the aforementioned embodiments, the LCD can be driven even in case that the output voltage of the ramp voltage-generating circuit does not keep the maximum voltage VH or the voltage V0 in a certain period. Although the LCD is driven in the normally white mode in the aforementioned embodiments, it is evident that the invention can be applied to the LCD driven in a normally black mode. The invention can be applied not only to a case that the LCD is driven by a vertical voltage but also to a case that it is driven by a horizontal voltage (it is a LCD driven in a IPS (in plane switching) mode).

In the LCD according to the invention, the output voltage of the ramp voltage-generating circuit takes the maximum or minimum value immediately after a certain scanning line is going to be selected, decreases slowly with the passage of time in case that the maximum value is generated, and increases slowly in case that the minimum value is generated. If a certain voltage applied to a pixel electrode belonging to a selected scanning line is watched, since an output voltage of a sampling & holding circuit can be applied to the pixel electrode for a long time as the difference in the potential applied to the pixel electrode between the present and preceding scannings is large, even a TFT with the low carrier mobility can make the voltage applied to the pixel electrode follow that applied to the data bus line easily. Moreover, since a width of a channel of the TFT can be narrowed in case that the sufficient carrier mobility is secured, the LCD can be small-sized and aperture ratio of the pixel can be increased.

Although the invention has been described with respect to specific embodiment for complete and clear disclosure, the appended claims are not to be thus limited but are to be construed as embodying all modification and alternative constructions that maybe occurred to one skilled in the art which fairly fall within the basic teaching herein set forth.

What is claimed is

1. A liquid crystal display (LCD, hereinafter), comprising:
a LCD panel which is composed of gate bus lines, data bus lines intersecting said gate bus lines, switching elements respectively situated close by intersections of said gate and data bus lines and connected therewith, pixel electrodes respectively connected with said switching elements, common electrodes respectively situated opposite to said pixel electrodes, and liquid crystals respectively driven by said pixel and common electrodes,
a ramp voltage-generating circuit for generating a reference voltage which is defined as a difference in a potential between an output terminal of said ramp voltage-generating circuit and said common electrodes,
wherein an absolute value of said reference voltage varies periodically synchronizing with a signal for changing said gate bus line to be selected and decreases slowly in a predetermined period, and a sign of said reference voltage alternates between positive and negative whenever said gate bus line to be selected is changed,
a data-driver circuit which is supplied with said reference voltage and video signals corresponding to respective pixels and generates brightness signals to be supplied to said respective data bus lines, and
a gate-driver circuit which is connected with said respective gate bus lines and on/off controls said respective switching elements,
wherein said absolute value of said reference voltage takes a maximum value after said sign thereof alternates, decreases slowly thereafter, and takes a minimum values in a final stage.

2. A LCD according to claim 1, wherein:
said absolute value of said reference voltage maintains said minimum value for a certain time after said absolute value of said reference voltage reaches said minimum value.

3. A LCD according to claim 1, wherein:
said absolute value of said reference voltage maintains said maximum value for a certain time after said absolute value of said reference voltage reaches said maximum value.

4. A LCD according to claim 1, wherein:
said absolute value of said reference voltage is represented as a series connection of two or more segments of lines with two or more kinds of negative inclinations.

5. A LCD according to claim 1, wherein:
said absolute value of said reference voltage is represented as a nonlinear decreasing voltage.

6. A method for driving a LCD comprising a LCD panel composed of gate bus lines, data bus lines intersecting said gate bus lines, switching elements respectively situated close by intersections of said gate and data bus lines and connected therewith, pixel electrodes respectively connected with switching elements, common electrodes respectively situated opposite to said pixel electrodes, and liquid crystals respectively driven by said pixel and common electrodes, comprising the steps of:
selecting said gate bus line preceding a signal for instructing a horizontal scanning to start,
supplying a reference voltage generated by a ramp voltage-generating circuit to a data driver circuit connected with said respective data bus lines,
wherein said reference voltage is defined as a difference in a potential between an output terminal of said ramp voltage-generating circuit and said common electrodes, and an absolute value of said reference voltage decreases slowly in a predetermined period,
converting video signals corresponding to respective pixels into pulse width modulated signals by means of said data-driver circuit,
supplying brightness signals to said respective data bus lines in accordance with said pulse width modulated signals and said reference voltage by means of said data-driver circuits, and
on/off controlling said respective switching elements in order to supply said respective brightness signals to said pixel electrodes by means of a gate-driver circuit connected with said respective gate bus lines.

7. The method for driving a LCD as defined in claim 6, wherein:
a width of each of said pulse width modulated signals is wide as brightness is high in case that said LCD operates in a normally white mode, and
said width of each of said pulse width modulated signals is narrow as brightness is high in case that said LCD operates in a normally black mode.

8. The method for driving a LCD as defined in claim 6, wherein:
said pulse width modulated signal is generated on a basis of a difference between said video signal and a number of clock pulses with a predetermined period.

9. The method for driving a LCD as defined in claim 6, wherein:
said video signal is a digital data.
